(19) United States
(12) Patent Application Publication
(10) Pub. No.: US 2021/0350344 A1
(43) Pub. Date: Nov. 11, 2021

(54) INFORMATION PROCESSING SYSTEM, MOBILE TERMINAL, AND COMPUTER READABLE RECORDING MEDIUM

(71) Applicant: TOYOTA JIDOSHA KABUSHIKI KAISHA, Toyota-shi (JP)

(72) Inventors: Shintaro MATSUTANI, Kariya-shi (JP); Misato YOKOTA, Tokyo (JP); Yumiko OSAKI, Tokyo (JP); Atsushi YONEKI, Chigasaki-shi (JP); Kazunari TSUTSUMI, Tokyo (JP); Mitsunori ISODA, Tokyo (JP); Yuzo YAMADA, Nagoya-shi (JP)

(73) Assignee: TOYOTA JIDOSHA KABUSHIKI KAISHA, Toyota-shi (JP)

(21) Appl. No.: 17/236,062

(22) Filed: Apr. 21, 2021

(30) Foreign Application Priority Data
May 7, 2020 (JP) 2020-082209

(51) Int. Cl. G06Q 20/10; G06Q 20/32; G06Q 20/36; G06Q 10/02

(52) U.S. Cl. CPC G06Q 20/102; G06Q 10/025; G06Q 20/363; G06Q 20/3276

(57) ABSTRACT

An information processing system includes: a mobile terminal including a display, and a first processor including hardware; and a server including a second processor including hardware. The first processor is configured to display, on the display, tip information including whether tipping a service provider is expected and a standard tip amount in a region included in an itinerary, based on a travel plan registered by a user of the mobile terminal, and output, to the server, a settlement request of a tip using electronic money deposited in a first electronic wallet associated with the user. The second processor is configured to calculate the standard tip amount in the region included in the itinerary, output the tip information including the calculated standard tip amount to the mobile terminal, and perform settlement processing of the tip using the first electronic wallet in response to the settlement request.

The present application claims priority to and incorporates by reference the entire contents of Japanese Patent Application No. 2020-082209 filed in Japan on May 7, 2020.

### BACKGROUND

The present disclosure relates to an information processing system, a mobile terminal, and a computer readable recording medium.

JP 2005-527017 A discloses a technique of providing a tip (gratuity) calculation function in an order terminal that accepts orders at a restaurant or the like.

### SUMMARY

There is a demand to know the usual tip amount (amount of gratuity) and the timing of tipping (giving the gratuity) in advance before going to a place of receiving a service such as a restaurant.

There is a need for an information processing system, a mobile terminal, and a computer readable recording medium storing a program enabling a user to know the usual tip amount and the timing of giving the tip in advance.

According to one aspect of the present disclosure, there is provided an information processing system including: a mobile terminal including a display, and a first processor including hardware; and a server including a second processor including hardware, wherein the first processor is configured to display, on the display, tip information including whether tipping a service provider is expected and a standard tip amount in a region included in an itinerary, based on a travel plan registered by a user of the mobile terminal, and output, to the server, a settlement request of a tip using electronic money deposited in a first electronic wallet associated with the user, and the second processor is configured to calculate the standard tip amount in the region included in the itinerary, output the tip information including the calculated standard tip amount to the mobile terminal, and perform settlement processing of the tip using the first electronic wallet in response to the settlement request.

### BRIEF DESCRIPTION OF THE DRAWINGS

FIG. 1 is a schematic diagram illustrating a schematic configuration of an information processing system according to an embodiment;

FIG. 2 is a block diagram illustrating functional blocks of the information processing system according to the embodiment;

FIG. 3 is a sequence diagram illustrating an example of a control flow of a tip information request;

FIG. 4 is a sequence diagram illustrating a tip settlement control flow;

FIG. 5 is a flowchart illustrating an update flow of the tip information; and

FIG. 6 is a sequence diagram illustrating another example of the control flow of a tip information request.

### DETAILED DESCRIPTION

Hereinafter, an information processing system, a mobile terminal, and a computer readable recording medium storing a program according to an embodiment of the present disclosure will be specifically described with reference to the drawings. The present disclosure is not limited to the embodiment described below.

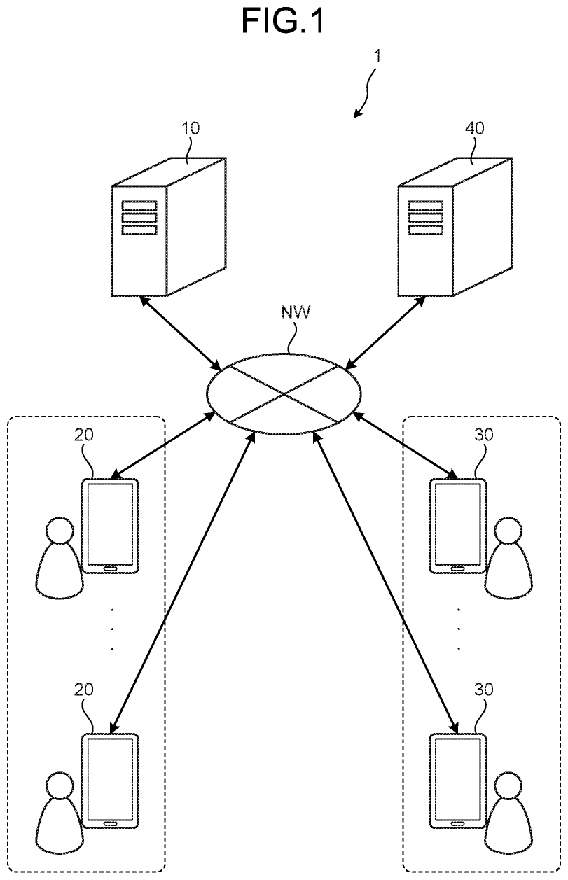

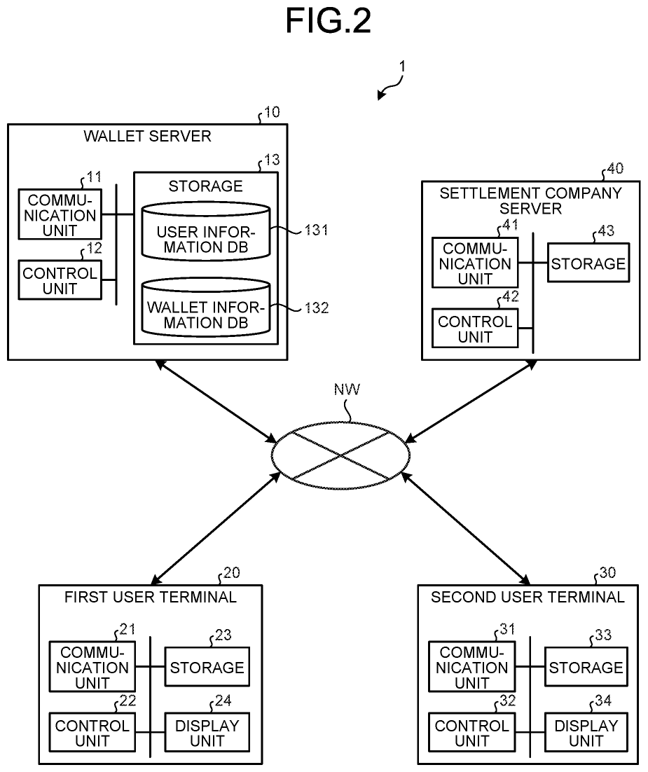

The configuration of the information processing system according to the embodiment will be described with reference to FIGS. 1 and 2. As illustrated in FIG. 1, an information processing system 1 of the embodiment includes a wallet server 10, a first user terminal 20, a second user terminal 30, and a settlement company server 40.

In the information processing system 1, the wallet server 10, the first user terminal 20, the second user terminal 30, and the settlement company server 40 are arranged to be able to communicate with each other through a network NW. The network NW includes, for example, the Internet line network, a mobile phone line network, and the like.

The wallet server 10 is a server that collectively manages a wallet system, and is managed by an administrator of the wallet system. As illustrated in FIG. 2, the wallet server 10 includes a communication unit 11, a control unit 12, and a storage 13.

The communication unit 11 includes, for example, a local area network (LAN) interface board, a wireless communication circuit for wireless communication, and the like. The communication unit 11 is connected to the network NW such as the Internet, which is a public communication network. Then, the communication unit 11 is connected to the network NW to communicate with the first user terminal 20, the second user terminal 30, and the settlement company server 40.

The control unit 12 includes a processor and a memory. The processor includes a central processing unit (CPU), a digital signal processor (DSP), a field-programmable gate array (FPGA), or the like. The memory is a main storage device, and includes a random access memory (RAM), a read only memory (ROM), and the like. This control unit 12 loads a program stored in the storage 13 into the work area of the memory (main storage device) and executes the program, and controls each of the components and the like through the execution of the program to implement functions that meet a predetermined purpose.

The storage 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage 13 may store an operating system (OS), various programs, various tables, various databases (DBs), and the like. The storage 13 includes a user information database 131 and a wallet information database 132.

The user information database 131 stores information about a user who uses the information processing system (hereinafter, referred to as “user information”). Examples of the user information include a user ID of a user who has registered to use the wallet system, a password, a user name, user contact information (for example, an address, a telephone number, an email address, etc.), a usage registration history, information about a payment method registered as a deposit method, information about a payment method registered as a settlement method, a code number at the time of settlement, a category, presence/absence of an approver, presence/absence of usage restriction, and the like. Out of the user information, the user ID and the password are used for authentication processing such as login to the wallet server 10.

The wallet information database 132 stores information about an electronic wallet of the information processing system 1 (hereinafter, referred to as “wallet information”). Examples of the wallet information include a user ID, an electronic money balance, an electronic money deposit history, an electronic money usage history, and the like. The wallet information database 132 also stores information about a settlement of the wallet system (hereinafter, referred to as “settlement information”). Examples of the settlement information include a user ID, a settlement method used for settlement (for example, electronic money payment, scan payment, code payment, etc.), a settlement history, and the like. Electronic money settlement is contactless settlement.

For example, an electronic wallet associated with the first user who owns the first user terminal 20 is a first electronic wallet. The wallet information about this first electronic wallet is stored in the wallet information database 132. Further, an electronic wallet associated with the second user who owns the second user terminal 30 is a second electronic wallet. The wallet information about this second electronic wallet is stored in the wallet information database 132. Then, the information processing system 1 is configured to enable tip (gratuity) transfer processing from the first electronic wallet associated with a traveler to the second electronic wallet associated with a service provider using electronic money.

Further, the storage 13 stores information about the travel plan of the first user, tip information, tip history information corresponding to the tip payment history, and regional information. The tip information is information including the standard tip amount for each predetermined region included in the itinerary of the travel plan, the timing information indicating the timing of giving a tip, and the total tip amount for the entire travel plan. The tip history information is associated with the wallet information. That is, the tip history information is information stored in association with the tip amount, which is the actual tip payment record using the electronic wallet, and the regional information when the tip was paid.

The first user terminal 20 is a mobile terminal owned by the first user who is a traveler. Examples of the first user terminal 20 include a smartphone, a mobile phone, a tablet terminal, a wearable computer, a personal computer, or the like owned by the user. Since the information processing system 1 assumes a large number of travelers, the information processing system 1 is a system assuming a large number of first user terminals 20.

Each of the first user terminals 20 includes a communication unit 21, a control unit 22, a storage 23, and a display unit 24. The communication unit 21, the control unit 22, and the storage 23 included in the first user terminal 20 are physically similar to the communication unit 11, the control unit 12, and the storage 13 included in the wallet server 10. The first user terminal 20 may be any mobile terminal as long as it may transmit and receive information to and from the wallet server 10 via the network NW.

The control unit 22 functions as a display control unit, a deposit method registration unit, a settlement method registration unit, a deposit processing unit, and a settlement processing unit by executing a program stored in the storage 23.

The control unit 22 controls display contents on the display unit 24 when the control unit 22 functions as the display control unit. The control unit 22 displays various screens on the display unit 24 based on the operation of the first user (touch operation, flick operation, and the like). Examples of the display screen include a login screen when logging in to the wallet system, a settlement screen when making a settlement by scan payment, etc., a usage history screen indicating a list of usage history such as a settlement, a payment history detail screen indicating details of payment history, a deposit screen when depositing electronic money in an electronic wallet, and the like. Further, the control unit 22 transitions screen to screen based on an operation of the first user.

The control unit 22 also registers a deposit method for depositing electronic money when the control unit 22 functions as a deposit method registration unit. The deposit method indicates a method of depositing electronic money in an electronic wallet, which is a virtual deposit/withdrawal account. Examples of the deposit method include a bank account and a credit card out of payment methods. By registering a bank account and a credit card as deposit methods, deposit of electronic money in an electronic wallet becomes possible. The payment method indicates a method that serves as a payment source when a settlement is made. Examples of the payment method include a bank account, a credit card, and an electronic money balance in an electronic wallet. To a credit card, a bank account is linked and a use amount of each card is withdrawn from the bank account at a later date.

The control unit 22 transmits, to the wallet server 10, a deposit method registration request asking for registration of a plurality of different payment methods operated by a plurality of companies as deposit methods to the electronic wallet. When the control unit 12 of the wallet server 10 receives a deposit method registration request from the first user terminal 20, the control unit 12 stores, as user information, the payment methods included in the deposit method registration request in the user information database 131 of the storage 13. Thus, the payment methods are registered in the user information database 131 as deposit methods.

The control unit 22 registers the payment methods to be registered as deposit methods also as settlement methods when the control unit 22 functions as a settlement method registration unit. The settlement method indicates a method of making a settlement using a payment method. Examples of the settlement method include scan payment, electronic money payment, and code payment. The scan payment, the electronic money payment, and the code payment are all settlement methods using the balance of the electronic money in the electronic wallet.

For example, the control unit 22 transmits a settlement request to the wallet server 10 or a store terminal for making a settlement using any of a plurality of preset settlement methods (electronic money payment, scan payment, code payment) using electronic money deposited in the electronic wallet. At that time, in a case where an electronic money payment is made, the control unit 22 transmits a payment request to the store terminal through the short-range wireless communication unit. A scan payment is a settlement made when a barcode or QR code (registered trademark) posted at a store is read with a camera or the like of the first user terminal 20. When a code payment is made, the control unit 22 transmits a payment request to the store terminal by having a reading unit such as the code reader or the like of the store terminal read a barcode or QR code (registered trademark) displayed on the first user terminal 20. When a scan payment is made, the barcode or QR code (registered trademark) displayed on the store terminal such as a cash register may be read by the first user terminal 20.

When the control unit 22 functions as a deposit processing unit, the control unit 22 deposits electronic money in an electronic wallet. The control unit 22 transmits a deposit request to the wallet server 10 for depositing electronic money in the electronic wallet by a payment method registered as a deposit method. When the control unit 12 of the wallet server 10 receives the deposit request from the first user terminal 20, the control unit 12 increases the electronic money balance in the electronic wallet based on deposit amount information included in the deposit request. That is, the control unit 12 updates the wallet information stored in the storage 13 according to the increased amount of the electronic money balance in the electronic wallet.

Further, when the control unit 22 functions as a settlement processing unit, the control unit 22 makes a settlement by the payment method. For example, when a scan payment is made, the control unit 22 transmits a payment request (settlement request) to the wallet server 10 by reading a QR code (registered trademark) posted at the store with the camera or the like of the first user terminal 20.

The control unit 22 may also make a settlement by a payment method other than the electronic money balance in the electronic wallet (for example, a bank account or a credit card) when the control unit 22 functions as a settlement processing unit. For example, when a deposit method registration request is transmitted from the first user terminal 20 to the wallet server 10, the control unit 22 transmits a registration request, which causes the payment methods included in the deposit method registration request to be registered as settlement methods, to the wallet server 10. That is, when the control unit 22 registers a payment method (for example, a bank account of bank X) to the wallet server 10 as a deposit method, the control unit 22 automatically registers the payment method (the bank account of bank X) also as a settlement method. “Registering a payment method as a settlement method” means making the payment method available as a payment source for settlement. In other words, it means making a scan payment possible using the bank account of bank X as the payment source. When the control unit 12 of the wallet server 10 receives a registration request from the first user terminal 20, the control unit 12 stores, as user information, the payment method included in the registration request in the user information database 131. Thus, the payment method is registered as a settlement method. Then, the control unit 22 transmits a payment request to the wallet server 10 for making a payment using any of a plurality of settlement methods by a bank account or a credit card. When the control unit 12 receives a payment request (settlement request) from the first user terminal 20, the control unit 12 transmits settlement amount information included in the payment request to the settlement company server 40. Then, the settlement processing is performed by information communication between the wallet server 10 and the settlement company server 40.

The storage 23 stores data of various screens displayed on the display unit 24 by the control unit 22. Further, in the storage 23, the user information, the wallet information, and the like are temporarily stored as needed.

The display unit 24 includes, for example, a touch panel display, and has an input function for accepting an operation by a user's finger, a pen, or the like, and a display function for displaying various types of information based on the control by the control unit 22.

The second user terminal 30 is a mobile terminal owned by a service provider who is the second user. Examples of the second user terminal 30 include a smartphone, a mobile phone, a tablet terminal, a wearable computer, a personal computer, or the like owned by the second user. Since the information processing system 1 assumes a large number of service providers, the information processing system 1 is a system assuming a large number of second user terminals 30.

Each of the second user terminals 30 includes a communication unit 31, a control unit 32, a storage 33, and a display unit 34. The communication unit 31, the control unit 32, the storage 33, and the display unit 34 included in the second user terminal 30 are physically similar to the communication unit 21, the control unit 22, the storage 23, and the display unit 24 included in the first user terminal 20. The second user terminal 30 may be any mobile terminal as long as it may transmit and receive information to and from the wallet server 10 via the network NW.

The settlement company server 40 is a server for managing an account and a credit card of a user, and is provided in a financial institution (for example, a bank, a shinkin bank, a credit union, a labor bank, etc.) and a credit card company. The settlement company server 40 includes a communication unit 41, a control unit 42, and a storage 43. The communication unit 41, the control unit 42, and the storage 43 included in the settlement company server 40 are physically similar to the communication unit 11, the control unit 12, and the storage 13 included in the wallet server 10.

The storage 33 stores account information and credit card information for each of users of the wallet system. Examples of the account information include a name of a user, an account number, an account balance, a deposit/withdrawal history, and the like. Examples of the credit card information include a name of a user, a credit card number, a credit card expiry date, a usage limit, a card usage history, and the like.

As described above, in the information processing system 1 including the wallet server 10, the first user terminal 20, the second user terminal 30, and the settlement company server 40, each user owns the first user terminal 20 or the second user terminal 30. In addition, an electronic wallet is registered for each user. In the electronic wallet, for example, four settlement methods: “A Pay”, “B Pay”, “C Pay”, and “D Pay”, are registered as a plurality of different settlement methods. “A Pay”, “B Pay”, “C Pay”, and “D Pay” may be any of settlement by a bank account, settlement by a credit card, or settlement by electronic money. Settlement by a bank account is a settlement method in which the settlement amount is withdrawn directly from the bank account. To the credit card, a bank account is linked and a use amount of the credit card is withdrawn from the bank account at a later date. To the electronic wallet, a deposit method such as a bank account and a credit card, which are methods of depositing in electronic money is linked, so that electronic money may be deposited in electronic money. When the electronic money is of a prepaid type, which may be deposited by cash or the like in advance, a deposit method such as a bank account or a credit card does not need to be linked to the electronic money.

In the information processing system 1 configured as described above, when the first user who owns the first user terminal 20 travels, whether tipping is expected in the itinerary, how much the usual tip amount is, and the timing of giving a tip, and the like may be informed to the first user who is a traveler in advance.

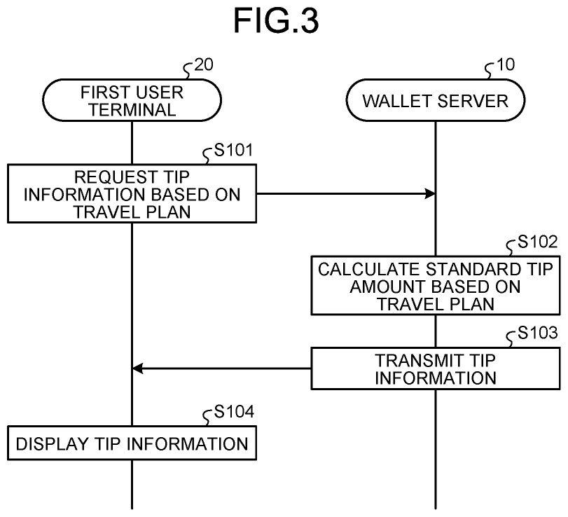

FIG. 3 is a sequence diagram illustrating an example of a control flow of a tip information request.

The first user terminal 20 transmits, to the wallet server 10, a tip information request based on the travel plan registered by the first user (step S101). In step S101, the first user may transmit a tip information request to the wallet server 10 specifying the travel plan information.

The wallet server 10 calculates the standard tip amount based on the travel plan (step S102). In step S102, the wallet server 10 identifies tip information about a region included in the itinerary based on the travel plan information. For example, the storage 13 of the wallet server 10 may store travel plan information. In this case, the travel plan information may be identified by referring to the information in the storage 13. Alternatively, travel plan information stored in a server other than the wallet server 10 may be used.

In step S102, when calculating the standard tip amount, the history information (tip history information) of settlement processing of tips using the electronic wallet is used. Specifically, the wallet information includes tip history information corresponding to the tip payment history. This tip history information includes tip amounts and timing information for giving the tips. Then, the wallet server 10 identifies a combination of the tip amount based on the tip history information and the region when the tip was paid. For example, in a first region of a certain language area, the standard tip amount is calculated to be a first amount. In a second region of another language area, the standard tip amount is calculated to be a second amount. The first amount and the second amount are different amounts. In this way, the standard tip amount may be calculated based on the combination of the history information about payment of tips in the past and the information about regions where the tips were provided. Further, the standard tip amount is determined to be an average or median of tip amounts included in the history information about the target region, or a tip amount most frequently paid. In addition, the history information includes timing information determined considering the culture and customs of the region.

The wallet server 10 then transmits the tip information including the calculated standard tip amount to the first user terminal 20 (step S103). In step S103, the tip information includes the standard tip amount for each predetermined region included in the itinerary of the travel plan, the timing information indicating the timing of giving the tip, and the total tip amount for the entire travel plan. The total tip amount is calculated as a prediction value using actual values according to the tip history information of other users in the itinerary. That is, the wallet server 10 calculates the prediction value of the total tip amount for the entire travel plan based on the tip history information.

When the first user terminal 20 acquires the tip information from the wallet server 10, the first user terminal 20 displays the tip information on the display unit 24 (step S104). In step S104, the standard tip amount and the timing information indicating the timing of giving the tip are displayed. The first user terminal 20 may also store the acquired tip information in the storage 23.

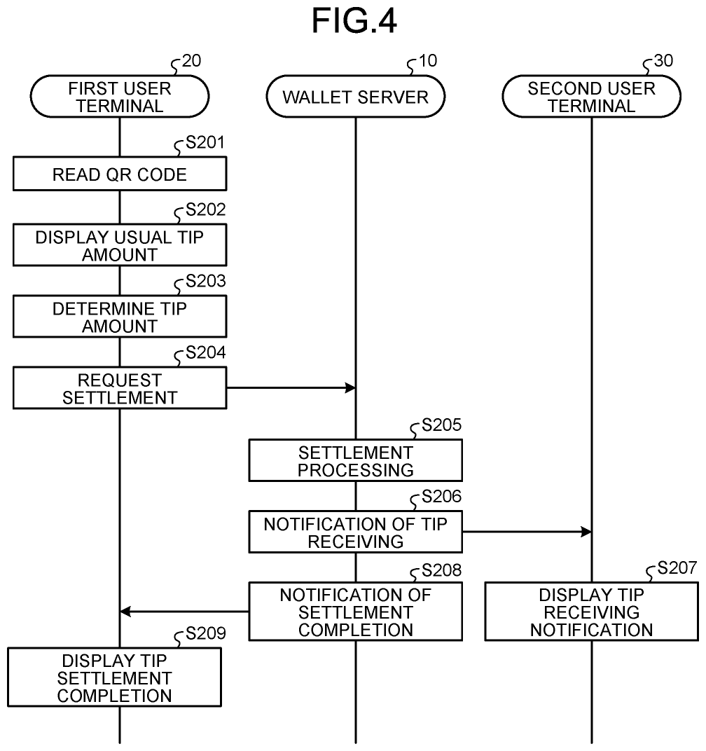

FIG. 4 is a sequence diagram illustrating a tip settlement control flow.

The first user terminal 20 reads a QR code (registered trademark) associated with the service provider (step S201). In step S201, the QR code (registered trademark) posted at the restaurant or the like is read with the camera or the like of the first user terminal 20. The QR code (registered trademark) read in step S201 is associated with the service provider information and the tip settlement request information to the electronic wallet associated with the service provider. What is read in step S201 is not limited to the QR code (registered trademark), but any identification code associated with the service provider may be read.

The first user terminal 20 displays the usual tip amount on the display unit 24 based on the information read in step S201 (step S202). In step S202, the usual tip amount for the service received from the service provider is displayed based on the information read in step S201. For example, the information read in step S201 includes information indicating the usual tip amount according to the service type. Alternatively, the information read in step S201 includes information indicating the usual tip amount in the region. Further, in step S202, a screen on which the first user may input or select the tip amount is displayed on the display unit 24. Thus, the first user terminal 20 may accept the tip amount determination operation from the first user.

The first user terminal 20 determines the tip amount according to an operation from the first user (step S203). In step S203, the operation of the first user on the screen displayed in step S202 is detected. In this case, the first user may perform a select operation of the tip amount according to the usual tip amount displayed in step S202.

The first user terminal 20 transmits, to the wallet server 10, a request of tip settlement (settlement request) using the electronic money deposited in the electronic wallet (step S204). The settlement request is a request for transferring a tip using electronic money to the service provider read in step S201 using the electronic wallet associated with the first user. In step S204, the first user terminal 20 specifies the electronic wallet associated with the first user, and performs a transfer processing request for transferring money to the electronic wallet associated with the service provider from the electronic wallet.

The wallet server 10 performs tip settlement processing using the electronic money of the electronic wallet associated with the first user based on the tip settlement request from the first user terminal 20 (step S205). In step S205, based on the user information and the wallet information stored in the storage 13 of the wallet server 10, the user information of the first user who is the source of the tip transfer and the service provider who is the receiver of the tip is identified. Then, settlement processing corresponding to the tip transfer is performed by transmitting and receiving information between the wallet server 10 and the settlement company server 40.

When the settlement processing related to the tip transfer is completed, the wallet server 10 transmits a notification indicating that the tip receiving is completed to the second user terminal 30 owned by the service provider (step S206). In step S206, the user information about the first user who paid the tip is also transmitted to the second user terminal 30.

When the second user terminal 30 receives the notification indicating that the tip receiving is completed, the second user terminal 30 displays the notification on the display unit 34 (step S207). In step S207, information about the tip amount deposited in the electronic wallet associated with the service provider and information about the user who paid the tip are displayed. The user information displayed in step S207 is a part of the wallet information and the user information stored in the storage 13. That is, in step S207, information that does not allow identification of the individual who paid the tip is displayed.

The wallet server 10 also transmits a notification indicating that the settlement of the electronic money related to the tip transfer is completed to the first user terminal 20 (step S208).

Then, the first user terminal 20 displays, on the display unit 24, information indicating that the settlement related to the tip transfer to the service provider is completed (step S209).

Here, when the tip settlement processing by the electronic wallet is performed, the wallet server 10 stores the history information in the storage 13. That is, the tip history information stored in the storage 13 increases every time tip settlement processing using the electronic wallet is performed. Therefore, the wallet server 10 is configured to update the standard tip amount to the latest information.

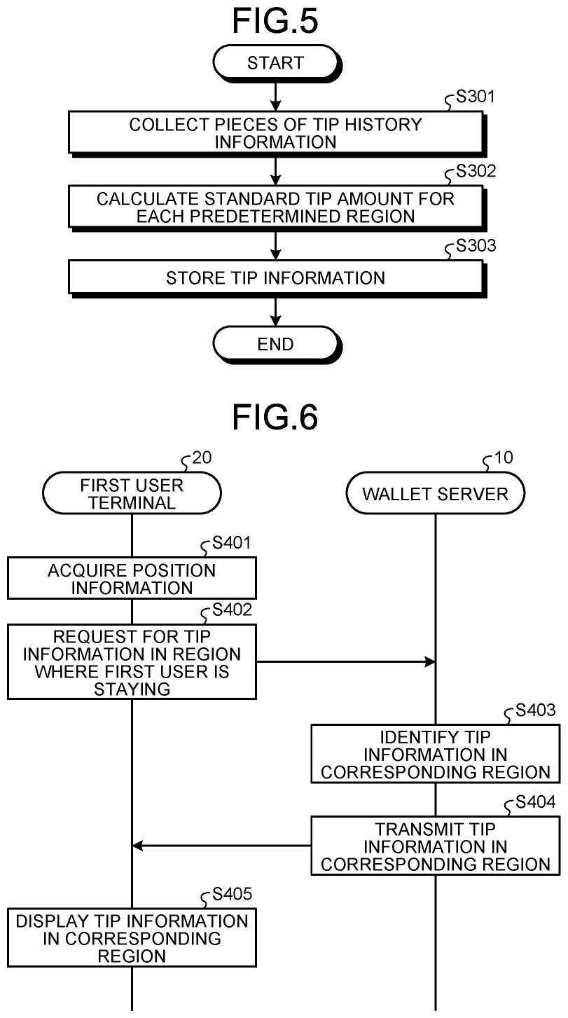

FIG. 5 is a flowchart illustrating an update flow of the tip information. The control illustrated in FIG. 5 is performed by the wallet server 10.

The wallet server 10 collects pieces of tip history information corresponding to the calculation targets based on the tip history information stored in the storage 13 (step S301). In step S301, pieces of tip history information are collected by limiting the calculation targets based on regional limitation for limiting to a predetermined region and time limitation for limiting to actual records within a predetermined period.

The wallet server 10 categorizes the pieces of information into predetermined regions such as language areas using the pieces of information collected in step S301 and calculates the standard tip amount for each predetermined region (step S302). In step S302, the standard tip amount is calculated for each of the regions into which the pieces of information are categorized based on the tip history information that is an actual record in the predetermined region within the predetermined period.

The wallet server 10 stores the tip information including the standard tip amount calculated in step S302 in the storage 13 (step S303). In step S303, the standard tip amount associated with a predetermined region may be stored in the storage 13 as tip information.

What is used by the control of FIG. 5 is not limited to the storage 13 of the wallet server 10, and the control may be performed using a storage provided in a server other than the wallet server 10. That is, the storage referred to in step S301 is not limited to the storage 13, and the storage that stores information in step S303 is not limited to the storage 13. In short, any storage may be used as long as the tip information is managed by the wallet server 10.

Thus, the user may access the tip information and the information related to the standard tip amount managed by the wallet server 10 by using the first user terminal 20.

FIG. 6 is a sequence diagram illustrating another example of the control flow of a tip information request.

The first user terminal 20 acquires the current position information of the first user terminal 20 (step S401). In step S401, the position information is acquired by the positioning unit of the first user terminal 20. The positioning unit of the first user terminal 20 receives, for example, a radio wave from a global positioning system (GPS) satellite and detects the position of the first user terminal 20. The position and route of the first user terminal 20 detected by the positioning unit as a position information acquisition unit of the first user terminal 20 are stored in the storage 23 as position information and travel route information in the itinerary.

The first user terminal 20 requests the wallet server 10 to provide tip information in the region where the first user is staying based on the position information acquired in step S401 (step S402). In step S402, the current position information including the position information acquired in step S401 and the request for tip information in the region corresponding to the position information are transmitted from the first user terminal 20 to the wallet server 10.

The wallet server 10 identifies the region corresponding to the current position information based on the request for the tip information from the first user terminal 20 and the current position information and identifies the tip information corresponding to the region (step S403). In step S403, the wallet server 10 identifies the tip history information in the corresponding region by referring to the storage 13 or the storage of another server using the information received in step S403. Thus, it is possible to identify the tip history information corresponding to the information request.

Then, the wallet server 10 transmits the tip information in the region to the first user terminal 20 according to the tip information identified in step S403 (step S404).

When the first user terminal 20 receives the tip information in the region, the first user terminal 20 displays the tip information on the display unit 24 (step S405).

As described above, according to the embodiment, it is possible for a user to know the usual tip amount and the timing of giving the tip in advance.

According to the present disclosure, it is possible for a user to know the usual tip amount and the timing of giving the tip in advance.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a mobile terminal comprising
a display, and
a first processor comprising hardware; and
a server comprising
a second processor comprising hardware, wherein the first processor is configured to
display, on the display, tip information including whether tipping a service provider is expected and a standard tip amount in a region included in an itinerary, based on a travel plan registered by a user of the mobile terminal, and
output, to the server, a settlement request of a tip using electronic money deposited in a first electronic wallet associated with the user, and
the second processor is configured to
calculate the standard tip amount in the region included in the itinerary,
output the tip information including the calculated standard tip amount to the mobile terminal, and
perform settlement processing of the tip using the first electronic wallet in response to the settlement request.

2. The information processing system according to claim 1, wherein the second processor is configured to calculate the standard tip amount based on tip history information of the settlement processing in the region included in the itinerary using a second electronic wallet associated with another user.

3. The information processing system according to claim 1, wherein
the first processor is configured to output, to the server, a request for providing the tip information based on the travel plan, and
the second processor is configured to
calculate a prediction value of a total tip amount based on the travel plan in response to the request for providing the tip information, and
output the calculated prediction value of the total tip amount to the mobile terminal.

4. The information processing system according to claim 3, wherein the first processor is configured to display, on the display, a prediction value of a total tip amount expected in the region included in a future itinerary in the travel plan based on the prediction value of the total tip amount.

5. The information processing system according to claim 1, wherein
the second processor is configured to
calculate the standard tip amount for each of predetermined regions, and
output the calculated standard tip amount for each of the predetermined regions to the mobile terminal, and
the first processor is configured to
display the tip information of a region where the user is staying on the display based on the standard tip amount for each of the predetermined regions and position information of the mobile terminal.

6. The information processing system according to claim 1, wherein the first processor is configured to
read an identification code associated with the service provider, and
output, to the server, the settlement request of the tip to the service provider by using the electronic money of the first electronic wallet.

7. The information processing system according to claim 6, wherein the first processor is configured to
display a screen enabling the user to select a tip amount on the display, and
when the first processor detects a determination operation of a tip amount by the user, output, to the server, the settlement request of the tip to the service provider according to the determined tip amount.

8. The information processing system according to claim 1, wherein
the tip information includes timing information indicating timing of tipping the service provider according to a region and a type of service, and
when the first processor displays the tip information on the display, the first processor is configured to display the timing information together with the standard tip amount.

9. A mobile terminal comprising:
a display; and
a processor comprising hardware, the processor being configured to
display, on the display, tip information including whether tipping a service provider is expected and a standard tip amount in a region included in an itinerary, based on a travel plan registered by a user of the mobile terminal, and
output, to a server, a settlement request of a tip using electronic money deposited in a first electronic wallet associated with the user.

10. The mobile terminal according to claim 9, wherein the processor is configured to display, on the display, a standard tip amount calculated as the standard tip amount in the region included in the itinerary.

11. The mobile terminal according to claim 10, wherein the processor is configured to display, on the display, the standard tip amount calculated based on tip history information of settlement processing of tipping in the region included in the itinerary using a second electronic wallet associated with another user.

12. The mobile terminal according to claim 10, wherein the processor is configured to:
display, together with the standard tip amount, timing information indicating timing of tipping the service provider according to the region and a type of service when the processor displays the tip information on the display; and
display a prediction value of a total tip amount calculated based on the travel plan.

13. The mobile terminal according to claim 10, wherein the processor is configured to display, on the display, the tip information of a region where the user is staying based on the standard tip amount calculated for each of predetermined regions and based on current position information of the user.

14. The mobile terminal according to claim 10, wherein the processor is configured to:
read an identification code associated with the service provider; and
output, to the server, the settlement request of the tip to the service provider by using the electronic money of the first electronic wallet.

15. The mobile terminal according to claim 14, wherein the processor is configured to:
display a screen enabling the user to select a tip amount on the display; and
when the processor detects a determination operation of a tip amount by the user, output, to the server, the settlement request of the tip to the service provider according to the determined tip amount.

16. A non-transitory computer-readable recording medium on which an executable program is recorded, the program causing a processor of a computer to execute:
displaying, on a display, tip information including whether tipping a service provider is expected and a standard tip amount in a region included in an itinerary, based on a travel plan registered by a user, and
outputting, to a server, a settlement request of a tip using electronic money deposited in a first electronic wallet associated with the user.

17. The non-transitory computer-readable recording medium according to claim 16, wherein the program causes the processor to execute displaying, on the display, a standard tip amount calculated as the standard tip amount in a region included in the itinerary.

18. The non-transitory computer-readable recording medium according to claim 17, wherein the program causes the processor to execute:
displaying, together with the standard tip amount, timing information indicating timing of tipping the service provider according to the region and a type of service when the processor displays the tip information on the display; and
displaying a prediction value of a total tip amount calculated based on the travel plan.

19. The non-transitory computer-readable recording medium according to claim 17, wherein the program causes the processor to execute:
reading an identification code associated with the service provider; and
outputting, to the server, the settlement request of the tip to the service provider by using the electronic money of the first electronic wallet.

20. The non-transitory computer-readable recording medium according to claim 19, wherein the program causes the processor to execute:
displaying a screen enabling the user to select a tip amount on the display, and
when the processor detects a determination operation of a tip amount by the user, outputting, to the server, the settlement request of the tip to the service provider according to the determined tip amount.
